(19) United States
(12) Patent Application Publication
(10) Pub. No.: US 2006/0136315 A1
(43) Pub. Date: Jun. 22, 2006

(54) Commissions and sales/MIS reporting method and system

(76) Inventors: Shiva Muthiki, Deer Park, NY (US); Michael Hamian, Commack, NY (US); Robert Zeichner, Coral Springs, FL (US); Daniel P. Cleary, Smithtown, NY (US); Zulfikar J. Somji, Levittown, NY (US)

Correspondence Address: KAYE SCHOLER LLP, 425 PARK AVENUE, NEW YORK, NY, 10022-3598, US

(21) Appl. No.: 11/267,894

(22) Filed: Nov. 4, 2005

Related U.S. Application Data
(63) Continuation-in-part of application No. 10/799,253, filed on Mar. 12, 2004.
(60) Provisional application No. 60/625,742, filed on Nov. 5, 2004.

(51) Int. Cl. G06Q 40/00

(52) U.S. Cl. 705/35

(57) ABSTRACT

In one example, a method of generating commissions documents comprises calculating commissions earned by a party based, at least in part, on stored data related to the party, generating at least one file comprising at least one of the calculated commissions and the stored data, and converting the at least one file into at least one read-only file. The read only file may be a PDF file or a read-only HTML file, for example. Access may be selectively provided to the file via a network, based on login information. The file may be generated based on a position of the user in a hierarchy table defining relationships between users, such as sales representatives and supervisors. Selection links to information may also be displayed to a user based, at least in part, on the login information, to the user. The file may be e-mailed to users. Systems are also disclosed.

The present application claims the benefit of U.S. Application No. 60/625,742, filed on Nov. 5, 2004, which is assigned to the assignee of the present invention and is incorporated by reference herein. The present application is also a continuation-in-part of U.S. application Ser. No. 10/799,253, filed on Mar. 12, 2004, which is also assigned to the assignee of the present invention and is also incorporated by referenced herein.

### FIELD OF THE INVENTION

Methods and systems for selectively providing access to calculated commissions and sales/management information system information.

### BACKGROUND OF THE INVENTION

FIG. 1 is a schematic diagram of an example of a credit and debit card transaction system 10 in the United States. When a credit or debit card transaction is processed, data required to effectuate (or settle) the transaction is entered in a terminal, a request for authorization to complete the transaction (based on the transaction data) is generated, an authorization is either granted or denied, and if authorization is granted, necessary funds to effectuate the transaction are transferred. Such a transaction typically involves multiple parties including a Card Holder 12, an Acquiring Bank 14, a Merchant 16, a Bank Card Association 18, and an Issuing Bank 20. While only one of each party is shown for ease of illustration, it is understood that there may be a plurality of each type of party in the credit card transaction system 10.

The Card Holder 12 is an entity, such as a person or business, that purchases goods or services from the Merchant 16 using a card, such as a credit card or debit card, issued by the Issuing Bank 20. The Merchant 16 is an entity, such as a business or person, that sells goods or services and is able to accept credit and/or debit cards to complete the sale. The Merchant 16 may be a point of sale (“POS”) merchant, for example.

The Bank Card Association 18 is a card payment service association (such as Visa, MasterCard, Discover and American Express) that is made up of member financial institutions. The Bank Card Association 18, among other things, sets and enforces rules governing their cards and conducts clearing and settlement processing. The Bank Card Association 18 neither issues cards nor signs merchants. Instead, it licenses financial institutions, such as the Issuing Bank 20, to issue cards, and licenses the Acquiring Bank 14 to acquire merchants' sales slips under the Association's brand name. The Bank Card Association 18 then manages the transfer of transaction data and funds between the Issuing Bank 20 and the Acquiring Bank 14. In addition, the Bank Card Association 18 maintains national and international networks through which data and funds are moved between the Card Holder 12, the Merchant 16, the Acquiring Banks 14 and the Issuing Bank 20.

The Acquiring Bank 14 is an entity that owns the legal relationship with the Merchant 16. The Acquiring Bank 14 provides services and products to the Merchant 16, and buys (acquires) the rights to the sales slips of the Merchant 16. The Acquiring Bank 14 credits the value of the sales slip to the Merchant's account at the Acquiring Bank. The Acquiring Bank 14 effectuates payment to the Merchant 14 upon authorization of a card transaction and charges the Merchant 14 a fee for handling each transaction. The Acquiring Bank 14 may have one or more Partners 15 that specialize in processing card transactions and/or offers additional services and products. The Partner 15 may be a bigger bank, such as J.P. Morgan Chase & Co., New York, N.Y., or a processor of transactions, such as First Data Merchant Services (“FDMS”), Melville, N.Y., for example. The combination of the Acquiring Bank 14 and one or more Partners 15 is referred to as an “Alliance” 17.

The Issuing Bank 20 issues cards to approved Card Holders, such as Card Holder 12, and sends bills to and collects payment from the Card Holder 12.

A Platform 22 serves as the liaison between the Merchant 16 and the Bank Card Association 18. The Platform 22 seeks authorization for the credit card transaction and conveys the authorization or rejection to the Merchant 16. The Platform 22 also computes the interchange fees associated with each credit card transaction processed by the Merchants 16 in accordance with predetermined business rules established by the Bank Card Associations 18. The Platform 22 may be FDMS, for example.

Thus, suppose the Issuing Bank 20 issues a credit card to the Credit Card Holder 12 (A). The Credit Card Holder makes a $50.00 purchase at a Merchant 16 (B). Upon inputting transaction data, the Merchant 16 requests authorization from the Platform 22 (C). The Platform requests authorization from a Bank Card Association 18 (D) and ultimately the Issuing Bank 20 (E). The request for authorization is transmitted from the Merchant 16 to the Issuing Bank 20 through the Platform 22 and Bank Card Association 18. The resulting authorization (or rejection) (F) is then issued by the Issuing Bank 20 and transmitted back to the Merchant 16 through the Bank Card Association 18 (G) and the Platform 22 (H).

Upon completion of the transaction, the Merchant 16, at some subsequent point in time, is paid the transaction price by the Acquiring Bank 14 (I) that has purchased the rights to the Merchant's sales slips (J). The Acquiring Bank 14 then receives payment from the Issuing Bank 20 (K). The Acquiring Bank 14 and the Issuing Bank 20 typically have their own clearing networks to effectuate their payments. For example, the Partner 15 of the Acquiring Bank 14 may provide a clearing network.

Alliances 17 typically offer a range of credit and debit related services and products to the Merchants 16, such as credit cards, debit cards, electronic check processing, point of sale terminals, software, etc. The Alliances 17 may hire sales representatives (“sales reps”) to offer the services and products to the Merchants 16. The sales reps are typically paid a commission for the sale and continued use of an Alliance's services and products. The commission may be based on many factors, such as net sales, net revenues, processing volume, the length of the relationship with the merchant, meeting targets, etc. Net sales, net revenues, etc., are offset by returns. Sales reps may be compensated based on different compensation plans in which commissions may be calculated in different ways. Alliances 17 may also offer many different promotional programs to encourage the sale of their services and products. As an added incentive to sales reps to sell particular services and products, an Alliance 17 may offer higher commissions for the period of time that the promotion is taking place. The computation of commissions may therefore be complex. This is particularly true if there are a large number of sales reps and multiple, different payment plans, which may be changed over time.

Alliances 17 may use custom designed software to calculate commissions for their sales reps. Commercially available software may be used, as well. Commissions calculation software is typically not flexible enough to handle more than a few payment plans that may change over time. Changes in payment plans may require months of rewriting of code and troubleshooting for successful implementation.

Whether the sales reps are hired by each financial institution or by a third party, the sales reps are typically paid by check through the mail. An itemized commissions statement summarizing the calculation of their commissions is typically included.

### SUMMARY OF THE INVENTION

First Data Merchant Services (“FDMS”), Melville, N.Y., employs sales representatives (“sales reps”) on behalf of multiple Alliances 17, to offer the services and products of the Alliances to others. FDMS pays the sales reps commissions based on the compensation plans of the Alliances represented by the sales rep, and provides the sales reps with employment benefits, such as health insurance. The Alliances 17 are thereby relieved of the administrative costs of employing and paying the sales reps. FDMS charges the Alliances 17 a fee for this service. The sales reps are assigned to offer the services and products of one Alliance 17 at a time and, in some cases, are assigned to merchants of particular sizes or types.

FDMS sales reps are informed of their earned commissions by statements mailed by the U.S. Postal Service. It is expensive to mail commissions statements to a large number of sales reps every month, due to postage costs, as well as supply and handling costs. An efficient, cost effective method of providing sales reps access to their commissions payment statements to sales reps is needed. An efficient way to provide summary information concerning the activities of the sales reps to managers is also needed.

Methods and systems for automatically preparing, providing selective access to, and/or e-mailing documents, such as sales commissions reports and/or Sales/Management Information Systems (“MIS”) reports based on predetermined business rules, are disclosed. Access and e-mail of documents may be provided via a network in communication with a user's personal computer, for example. The business rules may relate to the respective information or type of information that may be accessed by different users of the system. Users of the system may include sales reps selling products and services and the levels of supervisors, also referred to as managers, supervising the sales reps and other managers or supervisors. For example, sales reps may have access to their accrued commissions and the underlying information that contribute to the calculation of their commissions. Managers may have access to and/or receive commissions information and summary Sales/MIS information related to the activities of the sales reps they supervise or who are within their geographical or other area of responsibility. Managers who supervise other managers may have access to summary information related to the activities of the sales reps reporting to those managers, for example. Where a system pays commissions to sales reps representing third parties, such as Alliances, the third party may have access to and/or receive Sales/MIS information, as well. For example, account executives employed by the third party and overseeing the representation of the Alliance 17 by the system may have such access.

The rules determining the information users have access to may be defined by the third party or by the system. The system may then identify the information that a particular user of the system has access to based on login information provided by the user.

A commissions statement for a sales rep may be converted into a readily accessible, secure, read-only (non-alterable) file format, such as Portable Document Format (“PDF”) or a read-only HTML file, for example, for display to sales reps and other authorized users on a display device, such as a display of a PC, coupled to the network. The formatted reports may be displayed in a separate window, facilitating concurrent display of multiple reports. The formatted reports may also be stored on a hard disk or other such storage device by a user. The user may also have an option of viewing information in other formats, such as a spreadsheet. Microsoft® Excel is an example of such a spreadsheet. Use of a spreadsheet may facilitate record keeping by users. For example, a user may add new reports to a spreadsheet each month.

The reporting methods and systems of the embodiments described herein may be used with the methods and systems for automatically calculating sales commissions based on predetermined business rules disclosed in U.S. application Ser. No. 10/799,253 (“the '253 application”), filed on Mar. 12, 2004, which is assigned to the assignee of the present invention and is incorporated by reference, herein, for example. The commissions reporting systems and methods of the present invention may be used with other commissions calculating systems and methods, as well.

In accordance with one embodiment of the invention, a method of generating commissions documents is disclosed comprising calculating commissions earned by a party based, at least in part, on stored data related to the party, generating at least one file comprising at least one of the calculated commissions and the stored data, and converting the at least one file into at least one read-only file. The read only file may be a PDF file or a read-only HTML file. for example. The method may further comprise selectively providing access to the at least one read-only file via a network. Access may be selectively provided based, at least in part, on login information. Different parties may have access to different files. For example, sales representatives (“sales reps”), supervisors of sales reps, supervisors of sales rep supervisors, and third parties may all have access to different files. Files may be generated based, at least in part, on a position of a user in a hierarchy table defining relationships between users. The method may further comprise loading stored data into respective tables based, at least in part, on the hierarchy table and retrieving the information from the respective tables to generate the at least one file. The read-only file may also be sent to the user by e-mail.

In accordance with another embodiment of the invention, a method of generating financial documents is disclosed comprising collecting data related to activities of a plurality of sales reps, loading the collected data into respective tables based, at least in part, on a hierarchy table defining the relationships between the sales reps and supervisors of the sales reps, and generating at least one file based, at least in part, on data in at least one respective table. The activities may relate to transactions concerning products or services, for example. The products or services may be third party's products or services. Selection links to information may be displayed to a user based, at least in part, on the login information.

In accordance with another embodiment of the invention, a method of generating financial documents is disclosed comprising collecting data related to activities of a first plurality of parties, loading the collected data into respective tables based, at least in part, on a hierarchy table defining the relationships between the first plurality of parties and a second plurality of parties, and generating at least one file comprising data in at least one respective table.

In accordance with another embodiment of the invention, a method of generating commissions statements is disclosed comprising calculating commissions for a party based, at least in part, on stored data, generating at least one file comprising the calculated commissions and data related to the calculated commissions, and e-mailing the at least one file to the party. The file may be converted into a read-only file prior to e-mailing.

In accordance with another embodiment of the invention, a system to generate commissions statements is disclosed comprising memory and a processor. The processor is configured to collect data related to activities of a plurality of sales representatives, load the collected data into respective tables in the memory based, at least in part, on a hierarchy table defining the relationships between the sales representatives and supervisors of the sales representatives, and generate at least one file based, at least in part, on data in at least one respective table.

In accordance with another embodiment, a system for generating commissions statements is disclosed comprising memory and a processor. The processor is configured to calculate commissions for a party based, at least in part, on stored data, generate at least one file comprising the calculated commissions and data related to the calculated commissions, store the at least one file in the memory, and e-mail the at least one file to the party.

### BRIEF DESCRIPTION OF THE DRAWINGS

FIG. 1 is a schematic diagram of an example of a prior art credit card transaction system 10 in the United States;

FIG. 2 is a block diagram of an example of a Commissions, Sales/MIS Reporting System in accordance with an embodiment;

FIG. 3 is a more detailed schematic diagram of the Data Source of FIG. 2;

FIG. 4 is a more detailed schematic diagram of the Commissions Calculator of FIG. 2;

FIG. 5 is a summary of an example of a method of calculating commissions;

FIG. 6 is a more detailed schematic diagram of the Sales/MIS Calculator of FIG. 2;

FIG. 7 is a functional diagram of a User Hierarchy Table used by the Sales/MIS Calculator of FIG. 6;

FIG. 8 is a functional diagram of an example of the data flow among tables based on the hierarchy in the User Hierarchy Table of FIG. 7;

FIG. 9 is a more detailed schematic diagram of an example of the Reporting Manager of FIG. 2;

FIGS. 10a-10f are examples of graphical user interfaces that may be used in an embodiment of the present invention;

FIG. 11 is an example of a method of reporting commissions and Sales/MIS information in accordance with an embodiment;

FIG. 12 is an example of a method for selecting and displaying an appropriate graphical user interface (GUI) including available document types based on the login information; and

FIG. 13 is an example of a method for generating documents containing commissions and Sales/MIS information, for e-mailing to users.

### DETAILED DESCRIPTION OF THE PREFERRED EMBODIMENTS

In accordance one with embodiment of the invention, methods and systems are disclosed to automatically generate and selectively make available documents related to activities of parties, such as sales representatives (“reps”) employed by a company and other parties, such as their managers. The sales rep activities may be related to the sale, lease, installation, etc., of products and services, for example. If the sales reps represent third parties, the third parties may have access to certain information, as well.

In one example, one class of documents that are generated and accessible by authorized users include Statements, which relate to the calculation of commissions earned by sales reps. Statements may include a document summarizing the commissions earned in a time period, such as one month, as well as documents itemizing the components contributing to the earned commissions, such as the sales of equipment in the time period, the parties to the sales, and the dates of each sale, for example.

Another available class of documents is Rep Reports, which are cumulative summaries of particular commissions components over a different time period than a corresponding Statement for the same component. Rep Reports may also be accessed by sales reps. For example, a Statement may cover a monthly time period while a Report may cover a daily, quarterly, or year to date time period.

Another class of available documents is Sales/MIS Reports, which may be accessed by managers who supervise sales reps and managers of the managers who supervise the sales reps. Sales/MIS Reports provide summaries of activities of the sales reps reporting to the particular managers. If the sales reps represent an Alliance or other such third party, the Alliance or third party may also access Sales/MIS documents related to those sales reps.

The particular document or documents accessible to particular authorized users may be obtained by logging in to a website, for example. Particular documents may also be e-mailed to authorized recipients. Other or different reports may also be provided.

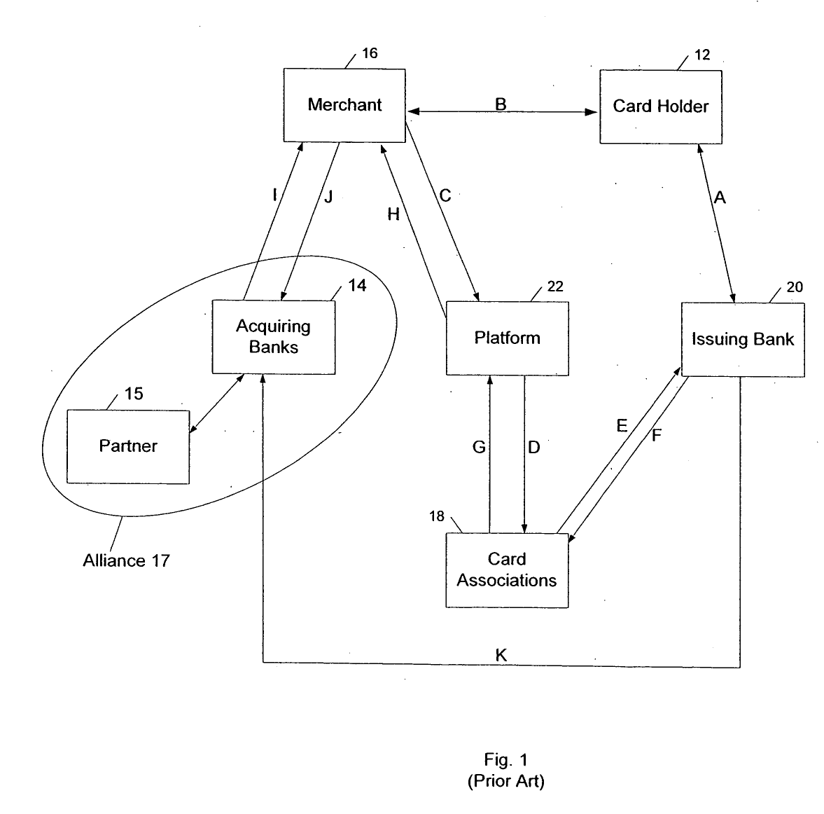

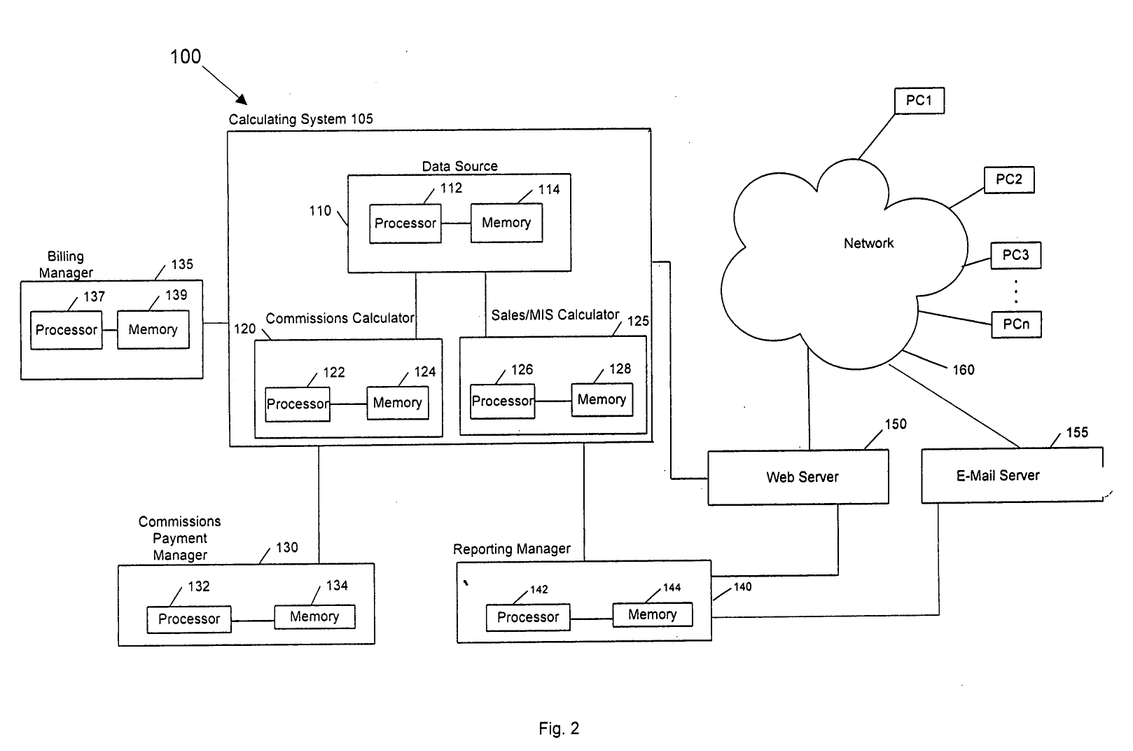

FIG. 2 is a block diagram of an example of a Commissions, Sales/MIS Reporting System (“System”) 100 in accordance with an embodiment of the invention. In this example, the System 100 comprises a Calculating System (“CS”) 105 including a Data Source 110, a Commissions Calculator 120, and a Sales/MIS Calculator 125. The Data Source 110 comprises a processor 112 and memory 114. The Data Source 110 accumulates data needed to calculate commissions and to prepare reports. Data may be received from individual merchant terminals or from processing centers that process transaction data from merchant terminals, such as the Platform 22 in FIG. 1, for example. Date may be conveyed via a Network 160, such as the Internet, an Intranet, a wide area network, etc., through a Web Server 150, for example. Sales reps may also provide certain data to the Data Source 110, as discussed further, below.

The Data Source 110 provides the data to the Commissions Calculator 120 and the Sales/MIS Calculator 125, both of which also comprise processors 122, 126, and memories 124, 128 respectively. The Commissions Calculator 120 calculates commissions based on the data provided by the Data Source 110 and business rules stored in the memory 122, for example, as described in the '253 application. The Sales/MIS Calculator 125 calculates sales and management information, also based on the data provided by the Data Source 110 and business rules stored in memory 128, for example, as well as the commissions calculated by the Commissions Calculator 120. The CS 105 provides the calculated commissions to a Commissions Payment Manager 130, which causes payment to sales reps of the calculated commissions. The Commissions Payment Manager 130 may be part of the payroll department of the CS 105, or an outside payroll payment company, for example. The Commissions Payment Manager 130 may comprise a processor 132 and memory 134, for example.

In accordance with an embodiment of the invention, a Reporting Manager 140, which also comprises a processor 142 and memory 144, for example, also receives data from the CS 105 to prepare documents for selective access and/or e-mailing to users. The Reporting Manager 140 is also coupled to the Web Server 150 to receive log-in information from the users and to cause display of requested information on user's display device. The Reporting Manager 140 determines which documents a user is authorized to access based on the log-in information. The Reporting Manager 140 may also be coupled to an E-mail server 155, to automatically e-mail documents to a PC of an authorized user. The e-mail server may be a Lotus Notes server, for example, available from IBM Corporation, Armonk, N.Y. A Microsoft® Outlook server or other such servers may be used, instead. The Web Server 150 may also communicate with the E-Mail Server 155.

Users may access the System 100 via personal computers (“PC”) PC1 through PCn, for example. The personal computers PC1 through PCn include respective display devices (not shown). The personal computers PC1 through PCn include operating systems, such as Windows 95, Windows 98 or Windows NT, for example, and Internet browsers, such as Internet Explorer. The personal computers PC1 through PCn also preferably include Adobe Acrobat Reader, available from Adobe Systems Incorporated, San Jose, Calif., via a free download at www.adobe.com, for example.

As discussed above, one party, such as FDMS, may hire sales reps to market the products and services of one or more third parties, such as Alliances 17, and pay commissions to the sales reps acting on behalf of the Alliances. A Billing Manager 140 may be provided to bill the Alliances 17 for the commissions paid by FDMS to respective sales reps. The Billing Manager 140 may also compute a service charge to be included in the bill. In this example, the Billing Manager 140 comprises a processor 142 and a memory 144. It is noted that the third party may also be the transaction processor or Platform 22 for the Alliances 17, as discussed above with respect to FIG. 1, but that is not required.

When a merchant agrees to purchase a new service or product promoted by a sales rep, the terms of the transaction are typically memorialized in and defined by a contract, referred to as a Merchant's Agreement. Some of the information required by the Commissions Calculator 120 is derived from the Merchant Agreements. The information may be entered into the Data Source 110 to be stored in the memory 112 by the CS 105, or by the respective sales rep, via one of the personal computers PC1 through PCn, for example. The personal computers PC1 through PCn may be connected to the Data Source 110 via the Network 160, for example. The Merchant Agreement may also be scanned into the Data Source 110 (or another such data source), to be stored in memory 112 as an image.

While one Data Source 110 is shown comprising one processor 112 and memory 114, a plurality of Data Sources 110 may be provided and/or a plurality of processors 112 and memory 114 may be provided in each Data Source 110. One or more Data Sources 110 may be at different locations and/or may be dedicated to different classes of sales reps servicing different classes of merchants. Multiple processors and memories may be provided in the other components of the CS 105, as well. The Data Source 110 may be a mainframe computer, such as an IBM Mainframe, for example. The Commissions Calculator 120 and the Sales/MIS Calculator 125 may each be a server, such as a server from Dell Corporation, Redrock, Tex. The memory 122 may comprise a database, such as an Oracle database server, available from Oracle Corporation, Redwood Shores, Calif. Multiple Web Servers 150 may also be provided to couple different components of the System 100 to the Network 160.

The memory 114 of the Data Source 110 may comprise one or more databases to store information needed to conduct the commissions calculations. Some of the required information is obtained from the Merchant's Agreements, as mentioned above. Information related to transactions conducted by the merchants 16 may be provided by the Platform 22 of FIG. 1 to the Data Source 110. The transaction information may be itemized for each merchant 16. For example, the total dollar value of the transactions conducted by a merchant 16 in a time period and the total dollar value of revenues generated by the merchant in the time period may be provided. The CS 105 may also sell and lease equipment on behalf of respective Alliances 17. Data concerning sales, lease, and installation of equipment is therefore readily available to the Data Source 110, as well.

In one example, commissions may be calculated based on business rules stored in tables in the memory 124, facilitating the incorporation of new rules and changes in existing rules, as described in the '253 application. Business rules may comprise associations between variables upon which commissions or components of commissions are calculated and conditions that determine the applicability of particular variables in particular circumstances. The business rules may vary among different compensation plans. In one example, a commissions calculation may be a function of the product of sales generated by an account and basis points. In this function, the value of the basis points is a variable. The particular basis points applied may depend, at least in part, on the age of an account generating the sales and a date the account was approved. The age and date are conditions. Values for the variables and the conditions may populate fields in the table. In one example of a table, fields in a row are associated and define one or more business rules. A business rule may also only comprise conditions. For example, whether commissions paid in one period for enrolling an account needs to be debited against commissions earned in a subsequent period (recoup), may depend on whether the account has been activated by conducting a sufficient level of transactions within a predetermined period of time of being approved (by passing a credit check, for example). In this example, the time period and the level of transactions are conditions of business rules that may be stored in tables and may vary among compensation plans. Functions or equations used to calculate commissions using the values of the variables may be written in software.

The commissions paid may be a sum of a variety of types of commissions, referred to as “commissions components,” which may be offset by commissions adjustments. The values of the commissions components are functions of a variety of inputs related to net sales, net revenues, etc., attributable to the sales rep. As mentioned above, net sales and revenues are offset by returns. In the implementations described herein, reference to sales, revenues, or other values upon which commissions are calculated means net sales, net revenues, etc., but that is not required to practice the invention.

In one example, sales reps represent one party, such as one Alliance 15. Sales reps may represent multiple parties as well. The Alliance 17 establishes one or more compensation plans defining business rules for use in calculating commissions. A sales rep may be compensated in accordance with one or more of the Alliance's compensation plans. The sales reps have portfolios of merchants 16 that they have enrolled into an Alliance's program. Sales attributable to a sales rep include direct sales of services or products to merchants 16 and sales generated by merchants in a sales rep's portfolio, through card transactions. Such transactions include credit card and debit card sales transactions with customers for the sales of products and services. Revenues attributed to a sales rep are the fees paid by merchants 16 in a sales rep's portfolio, typically per transaction, sale, lease, installation, etc. The applicable commissions components, the functions for calculating the commissions components, and the business rules determining the variables of the functions are defined by the Alliance 17 represented by the sales rep and the applicable compensation plan. An Alliance 17 may determine that the commissions paid are based on only one component, as well.

In general, sales reps are paid commissions for establishing new merchant accounts by enrolling new merchants into a program sponsored by an Alliance 17 and for the transactions conducted by the accounts in their portfolio. Sales generated in a time period for each merchant account is typically a significant factor in calculating commissions for a sales rep representing that account. Revenues earned by an Alliance 17 based on transaction fees may be considered along with or instead of sales.

For example, one commissions component, referred to as “residuals” or “residual payments,” is based on a percentage of a value of transactions generated by each account represented by the sales rep, in a time period. The value of the transactions may be the net sales, for example, which is multiplied by predetermined basis points to yield the residual payment commissions component. Residual payments in a time period may be capped. A minimum value of sales may have to be met in the time period before any residuals are paid. The predetermined basis points applied to calculate the residual payment may be based on the length of time the merchant has been enrolled, approved (passed credit check) or activated (met a predetermined level of activity) in a particular program, referred to as the “age” of the account, and may decrease as the age increases, for example. There may be limits on the length of time that residuals are paid for an account, such as for five years, for example. There may also be minimum levels that must be met in a time period before a residual payment is made for that time period. The values of the basis points and the associated conditions are determined by and may differ among the Alliances 17 and among the Alliance's compensation plans. The variables, these conditions, and identifications of a sales rep servicing the account, the Alliance 17 represented by the sales rep, and the compensation plan applicable to the sales rep, may be associated in one or more tables for calculation of this commissions component. Since the basis points are also dependent on the sales rep and Alliance compensation plan, they may also be conditions in the business rules for calculating this and other commissions components discussed below, depending on how the tables are organized. Other business rules may be used instead of or along with these rules.

Another commissions component in this example, referred to as “revenue performance,” is based on revenues earned from the fees paid by merchant accounts in a sales rep's portfolio, to the Alliance 15. The revenues attributable to a sales rep for each merchant account may be a function of the product of the revenues generated by that account and a particular value of basis points. In one example, the particular basis points, which is a variable, depends on a level of revenues achieved, which is a condition, as defined by business rules. In particular, an expected level of revenues is established by the Alliance 17 for each merchant account in the sales rep's portfolio. The business rules may associate basis points values with ranges defining the relation between the actual revenues and the expected level. For example, if the actual revenues is from 65% to 75% of the expected revenues, a first basis points is selected from the table. If the actual revenues is greater than 75% but less than or equal to 100%, a second basis points greater than the first basis points is selected from the table. If the actual revenues is greater than 100% of the expected revenues, a third, higher basis points is selected from the table. Additional ranges and basis points may be provided, as well. These variables and conditions may be associated with the applicable sales rep, Alliance and compensation plans in a table, as discussed above. The Alliance 17 and compensations may vary the ranges and associated basis points in their business rules. Other business rules may be used, as well.

Another commissions component may be earned for the approval of new merchants 16 in an Alliance's programs. As mentioned above, the approval process typically involves a credit check of the merchant 16. A fixed amount may be paid for each account approved in a time period. The fixed amount paid, which is the variable, may vary based on the actual number of new accounts approved, which is a condition, in the business rules. Different fixed amounts may be paid for each of the first 10 accounts signed in a time period, and each of the next 10 accounts signed in that time period, for example. Such ranges are also conditions. Another condition may be that a minimum number of new accounts must be met before any commissions are paid. In one example, a commission component, referred to as a “Masters Club Bonus,” is earned for enrolling more than a particular number of new accounts in a time period, such as one month. The variables and conditions are determined by the business rules of the compensation plan of the respective Alliance 17 applicable to a particular sales rep. The fixed amounts and ranges may be correlated with the sales rep servicing the account, the Alliance 17 represented by the sales rep and the applicable compensation plan, in one or more tables. Other business rules may be used as well.

Commissions are also paid for sales or revenues generated from special promotions. Special promotions may be established by Alliances 17, typically for limited periods of time, to provide added incentives for the sales reps to sell particular services or products. Such a bonus may be instituted to invigorate sales of lagging offerings, for example. In this implementation, a commissions component based on the sales of particular products and services is referred to as a Product Emphasis Bonus (“PEB”). The functions for calculating this commissions component and the business rules defining the variables and conditions may be similar to the calculation of the residual commissions component or the revenue performance commissions component, discussed above, depending on whether the commissions are based on sales or revenues, respectively. Similar associations may be provided in one or more tables. The commissions may be calculated based on other business rules, as well.

One or more commissions components may relate to equipment and products sold for an Alliance 17, such as credit and debit card validation terminals, printers, software, and Internet services. For example, a product sale commissions component and a product lease commissions component may be calculated for the sale and/or lease of such products, respectively. The commissions may be a function of a product of the net sales, net revenues (from fees associated with the transaction) and/or net number of units sold, for example, and applicable basis points. Conditions may include a minimum level of sales or value of sales or revenue, and/or unit sales or revenue growth targets that need to be met before any commissions are paid. If this commissions component for a particular Alliance compensation plan for a particular sales rep is based on sales or revenues, the functions and business rules may be similar to the residual or revenue components, respectively, which are discussed above. If this commissions component for an Alliance compensation plan for a particular sales rep is based on units sold, the functions and business rules may be similar to the Master Club Bonus component. As above, the business rules are stored in one or more tables. The commissions for any or all of the sales reps may be calculated based on other business rules, as well.

Another commissions component may relate to the installation of equipment or software, for example. Installation may include setting up a POS terminal, for example. If this commissions component for an Alliance compensation plan is based on units sold, the business rules may be similar to the Master Club Bonus component. If this commissions component for an Alliance compensation plan is based on sales or revenues generated by the installed equipment, the business rules may be similar to the residual or revenue components, respectively. In either case, the business rules may be stored in one or more tables. The commissions may be calculated based on other business rules, as well.

The commissions components above are examples. Alliances 17 may have compensation plans based on any or all these commissions components, which may be calculated based on similar or different business rules. Other commissions components may be used instead or along with the commissions components discussed above. The same commissions components may be calculated differently for different sales reps, dependent upon the Alliance they represent and the applicable compensation plan.

As mentioned above, the applicable commissions component or the sum of applicable commissions components may be offset by one or more commissions adjustments to determine the commissions paid. One common commissions adjustment is referred to as “recoup.” Recoup may be performed when an Alliance 17 authorizes the payment of commissions at the time of account approval, if the merchant 16 does not start processing transactions or does not meet a minimum level or value of transactions, in a predetermined time period, for example. Use or sufficient use is referred to as “activation.” If the merchant account is not activated within the predetermined time period, the commissions payment, which may have been earned in the Master Club Bonus, for example, is returned in a subsequent time period. Typically, the amount of the advance commission is subtracted from the sum of the earned commissions in the subsequent time period.

Business rules related to calculating recoup may define a time period after payment to the sales rep that the merchant account must activate or commissions are recouped, as determined by the Alliance compensation plan. The time period may be 60 or 90 days, for example. In this case, the time period and minimal value of activity are conditions. After the Master Club Bonus or other such commissions component is calculated based on approved accounts, the accounts may be stored in a table including fields to indicate the account approval date, whether the account has been activated, the activation date, if any, the sales rep servicing the account, the Alliance 17 represented by the sales rep and the applicable compensation plan. When sufficient activity is met, a flag is set in the appropriate field, and the date is entered in the date field, for example. If the field for the date does not indicate that activation has taken place by the number of days after approval defined by the business rules, then the commissions paid for that account is recouped in a current time period. The commissions paid is typically recouped by debiting the commissions earned in the current time period.

The recoup adjustment is optional for each sales rep or all sales reps. If recoup is not allowed in a jurisdiction, for example, it need not be implemented. Whether recoup is to be applied to a particular sales rep may be indicated in a table.

Another type of adjustment that may need to be made is referred to as miscellaneous adjustments, which compensate for commissions paid outside of a regular pay cycle. Operational discrepancies or adjustments caused by the late receipt of data required to compute a commissions component in a proper time period, for example, may require such adjustments. Other adjustments may be provided along with or instead of either or both of these adjustments.

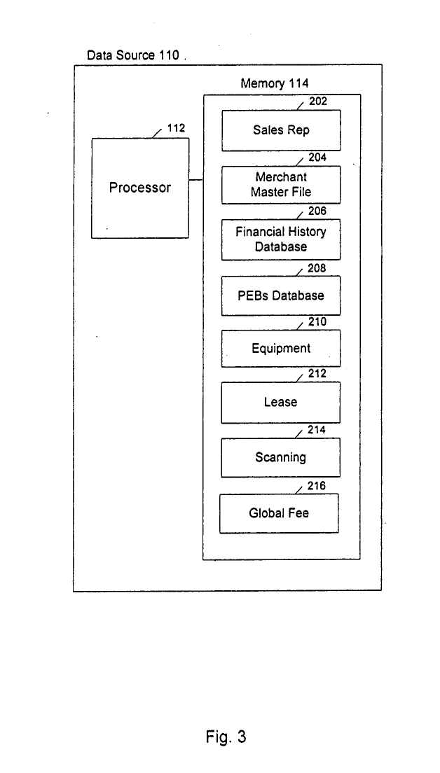

FIG. 3 is a more detailed schematic diagram of the Data Source 110. A plurality of databases 202 through 216 are provided, in which data required for the commissions and Sales/MIS calculations is stored.

A Sales Rep database 202 may be provided to store identifying information about the sales reps, such as their name, mailing address, hire date, termination date (if any), the Alliance or Alliances 17 they currently represent and have represented in the past, associated start and end dates for those representations, the applicable compensation plan or plans of each Alliance, the applicable time periods for the applicable plans, the merchant accounts serviced, etc.

A Merchant Master File database 204 stores accumulated transactional information related to each merchant account, such as total sales and revenues in a time period, to be used to calculate the commissions in the time period, as mentioned above. Other information stored in this database may include an identification of the sales rep servicing the account, the merchant approval date, the merchant activation date, and the accumulated number of enrolled, approved and/or activated accounts in the sales reps portfolio in a current time period. Residual, revenue, and Master Club bonus commissions components, for example, may be calculated based, at least in part, on the information in this database. Data concerning individual transactions related to each merchant account may be provided from the Platform 22 to be accumulated in the Merchant Master File database 202 or the data may be accumulated by the Platform 22 or the processor 112 prior to storage in the database.

A Financial History database 206 stores accumulated sales/revenue information for each merchant from prior time periods. This information may be provided by the Merchant Master File database 204. Past information may be needed to calculate residuals, recoup, and Sales/MIS information, for example.

A PEBs database 208 is provided to store accumulated information related to the Product Emphasis Bonus commissions component. The information may include total sales of the particular services or products subject to the PEBs bonus per merchant account. The responsible sales rep may be identified here, as well. If the sales reps and their merchant accounts are correlated in the Sales Rep database 202, then it is not necessary to include the information about the sales rep here and in other databases dedicated to commissions components.

An Equipment database 210 contains information about equipment sales, such as credit card validation terminals, printers, software, Internet services, etc., and the merchant making the purchase, which is used to calculate the product sale commissions component and Sales/MIS information. A Lease database 212 contains information about leased equipment and the merchant the equipment is being leased to, which is used to calculate the product lease commissions component. Installation information may be stored in the Equipment database 210, the Lease database 212 or in another database (not shown), for example. The Equipment database 210 and the Lease database 212 may be readily combined.

The Scanning database 214 contains images of the scanned Merchant Agreements, discussed above. Storing the Agreements enables the Agreements to be checked, if necessary.

A Global Fee database 216 stores the accumulated fees charged each merchant 16 by the Alliance 15 and Card Associations 18 to conduct each type of transaction, throughout the world. The accumulated fees include the discount rate charged by the sales rep servicing the account for the Alliances 17, minus the interchange fee charged by the Card Associations 18, plus assessments charged by clearing networks 13. Revenues in the calculation of commissions components may be based on fees, such as the discount rate, charged to the merchant account, for conducting transactions. Many different types of fees may be charged per transaction for different contracted services requested by the merchant. Contracted services include the type statement to be received and account credit, for example. Fees may be shown and summarized in the Sales/MIS reports, as well.

The databases 202 through 216 are merely examples of ways to organize and store information used by the Commissions Calculator 120 and the Sales/MIS Calculator 125. The information may be organized and stored in other ways, as well.

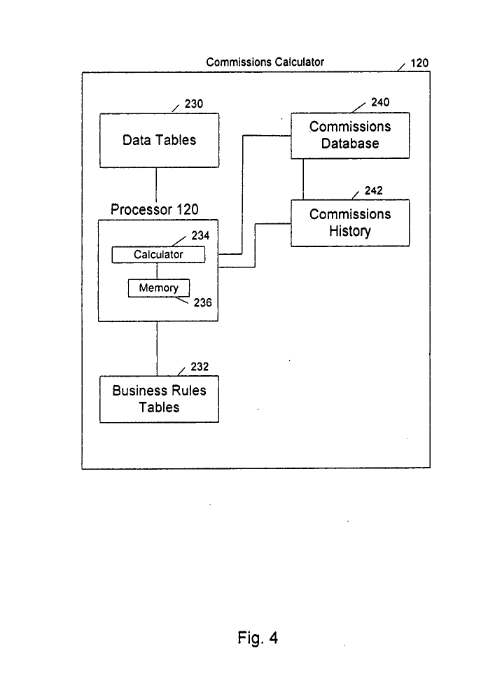

FIG. 4 is a more detailed schematic diagram of the Commissions Calculator 120, which comprises a Data Tables database 230, a Business Rules Tables database 232, and a Processor 234. The Processor 120 comprises a Calculator 234 and Memory 236. The Processor 120 loads the data received from the Data Source 110 into tables in the Data Tables database 230. The variables and conditions in the business rules are stored in tables in the Business Rules Tables database 232.

In the tables, applicable business rules are associated with the sales rep, the represented Alliance 17, the applicable compensation plan of each Alliance, the merchant account, etc., as appropriate. Information in the Financial History database 206 is provided to the Commissions Calculator 120 upon the request of the Processor 120, when needed to perform certain calculations. Examples of tables are provided in the '253 application, which is incorporated by reference herein and is identified further, above.

The Calculator 234 calculates the commissions for each sales rep, based on the data in the Data Tables database 230 and the business rules in the Business Rules Tables database 232. The commissions components described above are calculated by the Calculator 234 and stored in the Memory 236.

The stored values for the calculated commissions components are summed to yield a gross calculated commissions for each sales rep, which are also stored in the Memory 236. Miscellaneous adjustments are calculated, to determine payments made to some sales reps outside of the regular pay cycles. Operational discrepancies or adjustments due to late receipt of data, for example, may cause such adjustments. The miscellaneous adjustments for each sales rep, if any, are stored in the memory 236, as well. Recoup may then be optionally calculated for each sales rep, to determine how much, if any, money needs to be returned by a sales rep. The recoup value, if any, is stored in the Memory 236, as well. The adjustments may be calculated in any order.

The gross calculated commissions for each sales rep is offset by the miscellaneous adjustments and the recoup, if any, to yield a net calculated commissions for each sales rep. This is done by subtracting the miscellaneous adjustments and the recoup from the gross calculated commissions, for each sales rep. The sales rep is paid the net calculated commissions.

The Commissions Calculator 120 may comprise a plurality of modules to accommodate different business rules. Different modules may be dedicated to different classes of sales reps or merchants. For example, business rules may vary based on the size of merchant account or location of the merchant, for example. Recoup may be an adjustment for certain sales reps, but not others. Providing separate modules dedicated to particular classes may facilitate processing, because only the applicable business rules need to be stored in that module. In another example, sales reps that work with merchants above a particular revenue range, such as 2.5 million dollars, may be handled by one module. In another example, sales reps working with smaller sized merchants may be handled by another. Sales reps working with overseas (non-US) merchants may be handled by an overseas module. Sales reps may work with different merchant accounts that may be handled by different modules. A module may be provided to handle all sales reps, as well.

Accumulated data for each month may be provided from the Data Source 110 to the Commissions Calculator 120 on the 1st day of the following month, for example. Commissions may be calculated and paid by the end of every month.

The Commissions Calculator 120 also comprises a Commissions Database 240 and a Commissions History database 242. The net calculated commissions for each sales rep, as well as the commissions components and adjustments for a first time period, are stored in the Commissions Database 240. The first time period may be 13 months, for example. All the paid commissions and the underlying components and adjustments no longer stored in the Commissions Database 240 may be stored in the Commissions History database 242 for the life of the CS 105 or some other time period. The Payment Manager 130 (FIG. 2) effectuates payment to the sales rep based on the information stored in the Commissions Database 240.

The data from the databases 202 through 218 is provided to the Commissions Calculator 120 in the form of one or more ASCII files via an SQL feed, for example. An ASCII file may be provided from each database, for example.

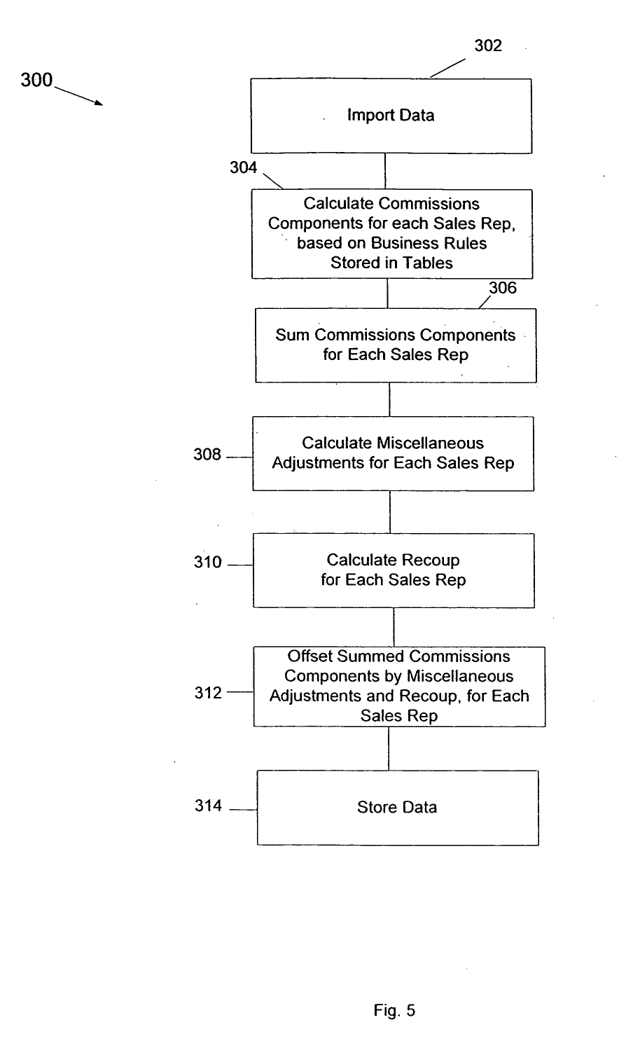

FIG. 5 is an example of a method 300 of calculating commissions, as described above and in the '253 application. Data necessary for the calculations is imported, in Step 302. Commissions components are calculated for each sales rep based on business rules stored in tables, in Step 304. The commissions components are summed to yield a gross calculated commissions for each sales rep, in Step 306. Miscellaneous adjustments are calculated for each sales rep, in Step 308. Recoup is calculated for each sales rep, in Step 310, if applicable. The summed commissions components, referred to above as the gross calculated commissions, is offset by the calculated adjustments and recoup for each sales rep, if any, to yield a net calculated commissions for each sales rep, in Step 312. The commissions components, miscellaneous adjustments and recoup for each sales rep are stored, in Step 314. In the example described above, the information is stored to the Commissions Database 240. The data is provided to the payroll department and the billing department of the CS 105.

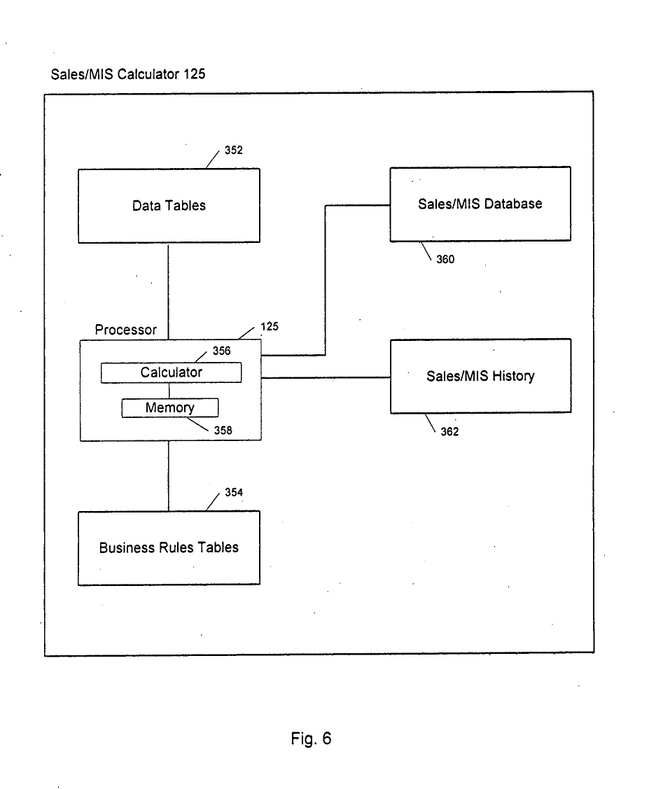

FIG. 6 is a more detailed schematic diagram of the Sales/MIS Calculator 125, which may have a similar structure to the Commissions Calculator 120. As above, a Database Tables database 352 and a Business Rules Tables database 354 are provided. The Processor 125 comprises a Calculator 350 and Memory 358. The Sales/MIS Calculator 125 loads the data received from the Data Source 110 into tables in the Data Tables database 352. The Processor 125 organizes the Sales/MIS data for the various reports, based on the data in the Data Tables database 352 and the business rules in the Business Rules Tables database 354, and the Calculator 350 sums the data, for example.

The Sales/MIS Calculator 125, in this example, also comprises a Sales/MIS Database 360 and a Sales/MIS History database 362. The calculated Sales/MIS data for a predetermined period of time, such as the prior 30-90 days, for example, may be stored in the Sales/MIS Database 360. Calculated Sales/MIS data no longer stored in the Sales/MIS Database 360 is stored in the Sales/MIS History database 362, for the life of the System 100 or some other time period.

Data may be provided from the Data Source 110 to the Sales/MIS Calculator 125 daily, for example. As above, the data may be provided in the form of one or more ASCII files via an SQL feed. The data is loaded into tables in the Data Tables database 352. The types of data may include: new accounts signed; signed accounts approved; approved accounts activated; transactions processed (in dollars); equipment sold, installed, and leased; and fees per sales rep and per merchant account, for example. The data is loaded in appropriate tables in association with an identification of the sales rep responsible for the related merchant account and an identification of the merchant account. Other associations may be provided in the tables, as appropriate. The loaded data of each type may be summed by the Calculator 350, for example, to facilitate generation of summary reports.

The Business Rules Tables database 354 includes rules for calculating and organizing the Sales/MIS data. One such table may be a User Hierarchy table, which associates the users of the System 100 with respect to other users based on the employee reporting structure (hierarchy) of the System 100. In one example, sales reps representing a particular Alliance are supervised by territorial managers, territorial managers are supervised by district managers, and district managers are supervised by regional managers. The regional managers report to one or more Alliance managers of the Alliance 17.

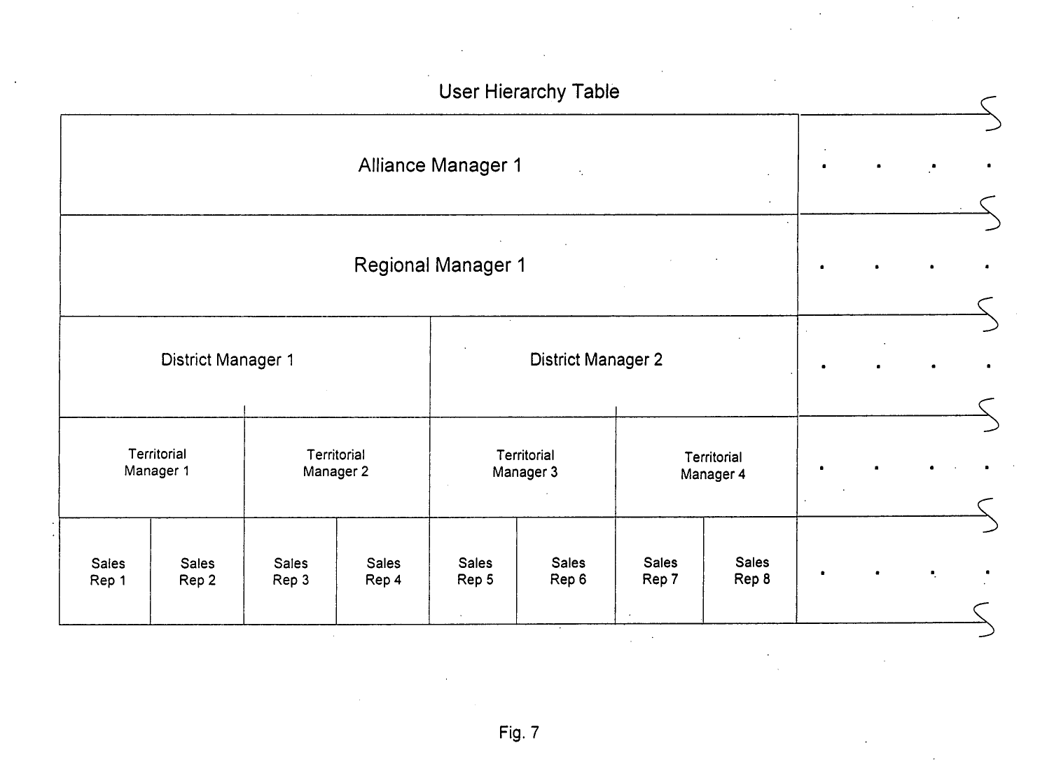

FIG. 7 is a functional diagram of a User Hierarchy Table reflecting such relationships. In FIG. 7, Sales Rep 1 and Sales Rep 2 are supervised by a Territorial Manager 1. Sales Rep 3 and Sales Rep 4, Sales Rep 5 and Sales Rep 6, and Sales Rep 7 and Sales Rep 8 are supervised by Territorial Managers 2, 3, and 4 respectively. Territorial Managers 1 and 2 are supervised by a District Manager 1 and Territorial Managers 3 and 4 are supervised by a District Manager 2. A Regional Manager 1 supervises the District Managers 1 and 2. The Regional Manager 1 is supervised by the Alliance Manager 1. All these parties represent the same Alliance 17. Additional Sales Reps, Territorial Managers, District Managers, Regional Managers, and/or Alliances 17 may be provided and organized in a similar hierarchy. Each party may access Sales/MIS data associated with parties beneath them in the User Hierarchy Table.

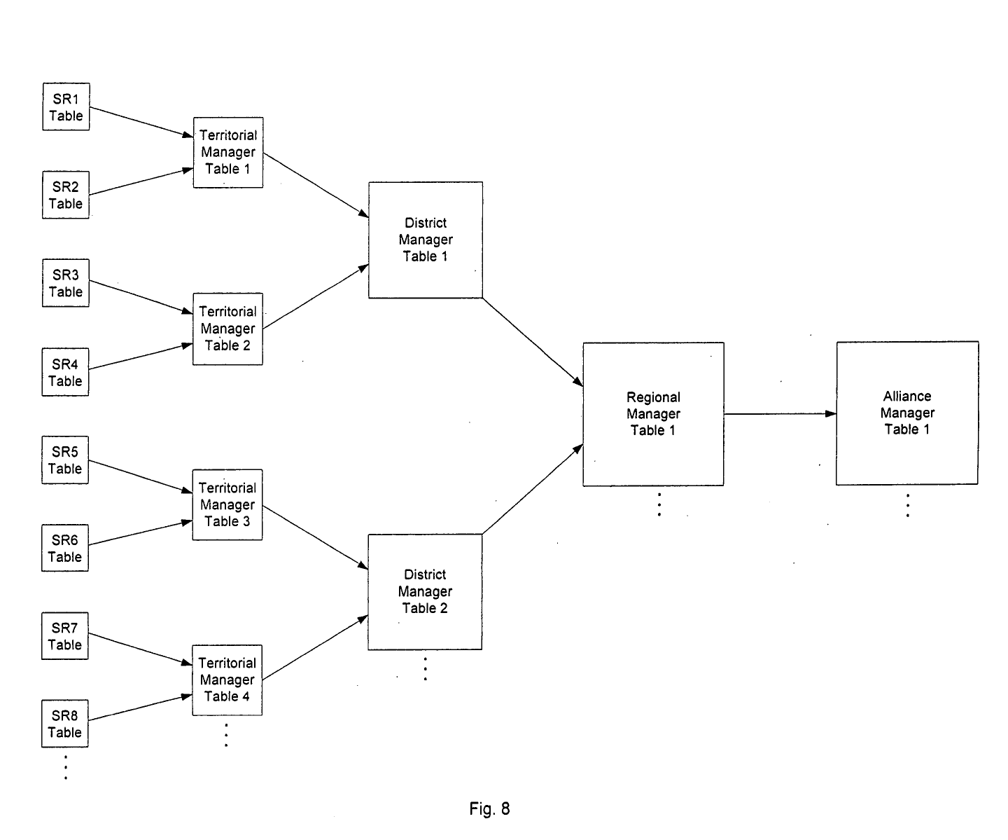

The Sales/MIS data is organized in tables by the Processor 125, in accordance with this hierarchy, based on the associations in the User Hierarchy Table. FIG. 8 is a functional diagram of an example of the data flow among tables based on the hierarchy in the User Hierarchy Table of FIG. 7. In FIG. 8, Sales Rep Tables SR1 through SR8 are shown. Each Sales Rep Table SR1 through SR8 is associated with a respective Sales Rep 1 through Sales Rep 8, in FIG. 7. Data from the SR1 Table and the SR2 Table, which correspond to Sales Rep 1 and Sales Rep 2 in FIG. 7, respectively, is loaded into the Territorial Manager 1 Table, which corresponds to the Territorial Manager 1 in FIG. 7. All the data and/or the calculated sums of the data may be loaded. Similarly, the data from the SR3 and SR4 Tables, the SR5 and SR6 Tables, and the SR7 and SR8 Tables are stored in the Territorial Manager 2, Territorial Manager 3, and the Territorial Manager 4 Tables, respectively. The data from the Territorial Manager Tables 1 and 2, which correspond to Territorial Managers 1 and 2 in FIG. 7, and from the Territorial Manager Tables 3 and 4, which correspond to the Territorial Managers 3 and 4 in FIG. 7, is loaded into the District Manager Tables 1 and 2, respectively. The District Manager Tables 1 and 2 correspond to the District Managers 1 and 2 in FIG. 7. The Data from the District Manager Tables 1 and 2 is loaded into the Regional Manager Table 1, which corresponds to the Regional Manager 1 in FIG. 8. Finally, in this example, the data from the Regional Manager 1 is loaded into the Alliance Manager Table 1, which corresponds to the Alliance Manager 1 of FIG. 7. Associations with the party to which the data is related may be provided from table to table, as well.

In one example, data relating to approved accounts by all the sales reps, provided by the Data Source 110 to the Sales/MIS Calculator 125, is initially loaded into data input tables in the Data Tables 352, as the data is received. The data may then be loaded into separate sales rep tables, or different portions of one or more sales rep tables, for each sales rep. The data may be summed for each sales rep and/or each account, in each table. Summed data may be stored in the table or in another location. In this example, it will be assumed that summed data is also in the table. The data and the summed data is then loaded in the appropriate tables higher up the hierarchy, in accordance with the User Hierarchy Table of FIG. 7 and the functional diagram of FIG. 8.

Other data types are similarly organized and summed in accordance with the User Hierarchy Table. Separate tables may be provided for each data type, or multiple data types may be combined in the same table. The tables may be in the Data Tables Database 352, in the memory 358 of the Processor 356, or in another location.

A Manager table may be provided in the Sales/MIS Calculator to correlate identifying information for all managers with the Alliance 17 they represent, who they report to, and who reports to them, etc. Such a table may be provided in the Data Source 110, instead.

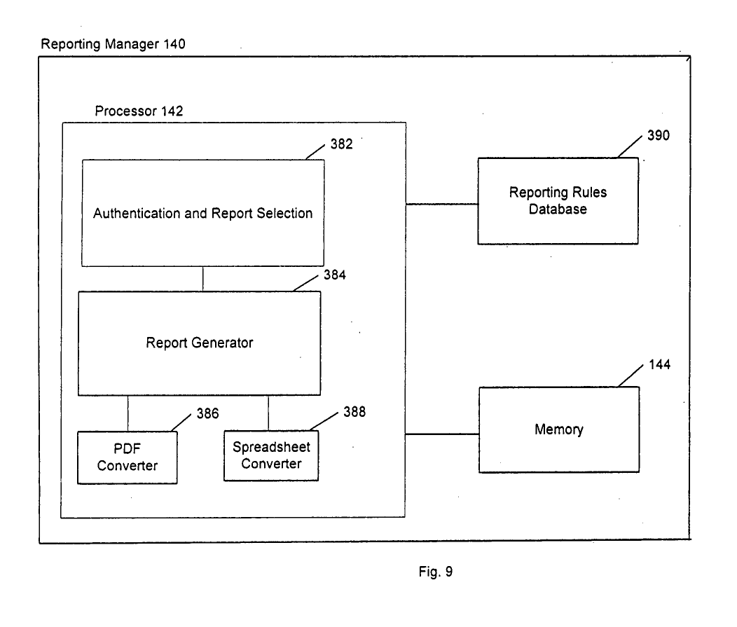

The Reporting Manager 140 prepares multiple types of documents for selective display to authorized users. FIG. 9 is a more detailed schematic diagram of an example of the Reporting Manager 140. The Processor 142 and the Memory 144 are shown. The Processor 142 comprises an Authentication and Report Selection module 380, a Report Generator module 382, a PDF Converter 384, and a Spreadsheet Converter 386. A Reporting Rules Database 390 is also shown, coupled to the Processor 142.

The Reporting Rules Database 390 comprises one or more tables correlating users with their login information and the documents each user is authorized to view. The user may be correlated with specific document types or with an access level. Access levels may be correlated to specific document types in one or more other tables, for example. All login information may be stored in a single table or separate tables may be provided for each user type. In one example, separate tables are provided for sales reps, territorial managers, district managers, regional managers and Alliance managers. Alternatively, certain digits of a user ID, such as the first two (2) digits, may be the same for all users of a certain type. For example, the first two digits of all sales reps may be 11; the first two digits of all territorial managers may be 22; the first two digits for all district managers may be 33; the first two digits of all regional managers may be 44; and the first two digits of all Alliance managers may be 55. The available document types may then be correlated with those first two digits.

The Report Generator 384 retrieves the data required to prepare a particular report from the tables in the Commissions Database 240 and/or the Sales/MIS Database 360, depending on the document type and the user. Data may also be retrieved from the Commissions History database 242 and the Sales/MIS database 362, depending on the time period covered by available reports. The Report Generator 384 may be programmed to access the proper table locations for the data for particular reports. The table locations may also be stored in a table in the Reporting Manager 140, as well. Continuing the example above, if the Territorial Manager 1 desires a Sales/MIS document containing information relating to approved accounts in the manager's territory, the Report Generator 384 will retrieve the data from the Territorial Manager Table 1 in FIG. 8. If the District Manager 1 requests the same information, the data will be retrieved from the District Manager Table 1 in FIG. 8.

The retrieved data may be stored in memory, such as the Memory 144. The Report Generator 384 processes the data into a predetermined format having a desired appearance, as a first file for a particular document. The PDF Converter 386 converts the first file into a second, PDF file, which is identical or nearly identical in appearance to a display of the first file. The PDF file is made available to the user for viewing on the display device of their PC, via the Network 160 and the Web Server 150. The Spreadsheet Converter 388 may convert the first file into a spreadsheet file, such as a Microsoft® Excel spreadsheet. In one example, that conversion is performed upon the request of the user. Rich Text Format, Microsoft® Word, or WordPerfect® may also be used, in which case other appropriate Converters would be provided.

The Report Generator 384, PDF Converter 386, and the Spreadsheet Converter 388 may use a reporting tool, such as Crystal Reports 8.5, Developer Edition, available from Business Objects SA, San Jose, Calif., for example, to create the first file document and then to convert the first file document into a PDF or spreadsheet file document. ASP server side scripting and JAVA script client side scripting may also be used. Crystal Reports 8.5, Developer Edition, includes an option to convert a document into a desired format, such as PDF, Microsoft® Word, rich text format (“RTF”), and Excel. The conversion may be performed with different front end programming languages, such as Visual Basic or Active Server Pages (“ASP”) for developing web applications. Exporting to PDF in Crystal Reports 8.5 retains the format and appearance of the original report, to a high degree. Generating a Crystal Report by the Report Generator 384 and converting the Crystal Report to PDF or Excel for viewing on a user's display device of their PC, may be provided by Crystal Report Controls, written in an ASP page, for example. First, the report is converted into a Crystal Report. Then, the Crystal Report is exported into a PDF format, or spreadsheet format by the PDF Converter 386 or the Spreadsheet 388, respectively. The read-only file can also be a read-only HTML file. A suitable converter may be readily provided.

In an example of the operation of an aspect of the System 100, documents are generated automatically on a regular basis by the Report Generator 384, converted into a PDF document by the PDF Converter 386, and stored in the memory 144, for example. The documents are then available for retrieval. Different types of documents may be generated at different times as defined by the business rules, for example.

When a user logs in to the System 100 by accessing the System's website at a web address, with the user's PC. A login graphical user interface (“GUI”) may be presented on the user's display device, through which the user provides login information, such as the user's user ID and password, to the System 100. The Authentication and Report Selection module 382 authenticates the user by comparing the user ID and password to a table in the Reporting Rules Database 390 correlating user ID with passwords of authorized users. Then the Authentication and Report Selection module 382 correlates the user ID with the documents or access level correlated with that user ID in a table in the Reporting Rules Database 390. Another GUI may then be displayed on the user's display device, presenting the available document types for selection. Alternatively, all available document types may be displayed but only the authorized document types may be selected.

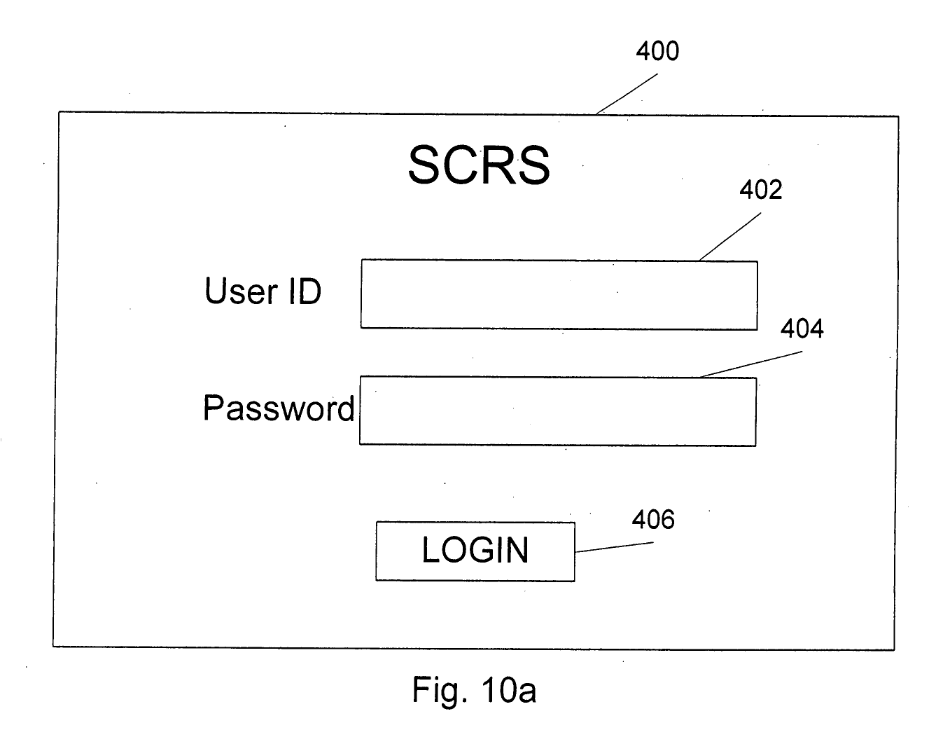

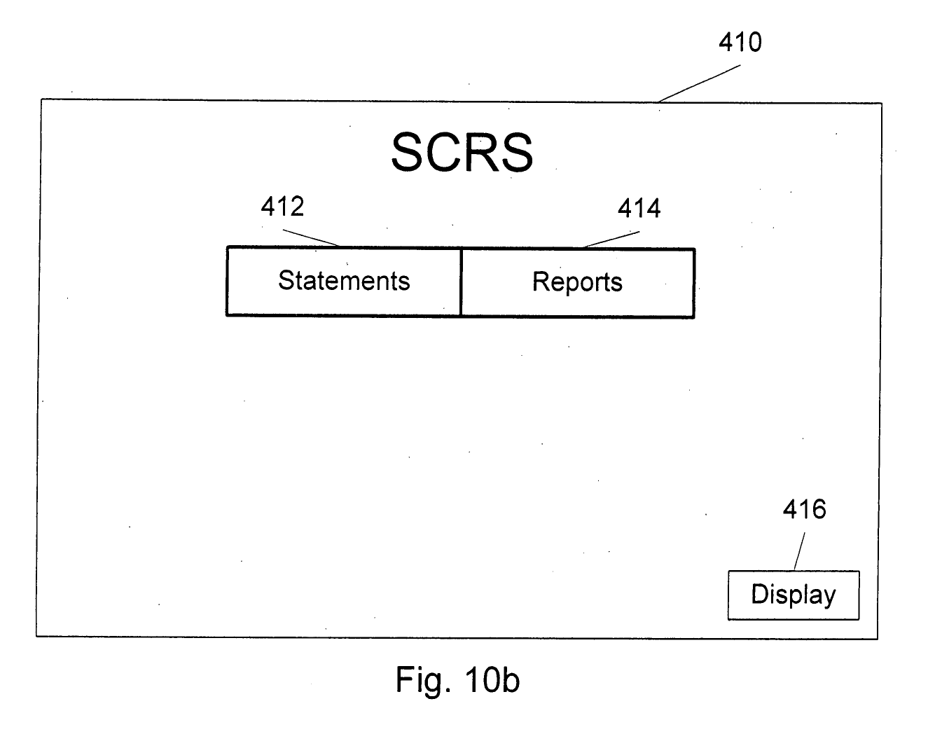

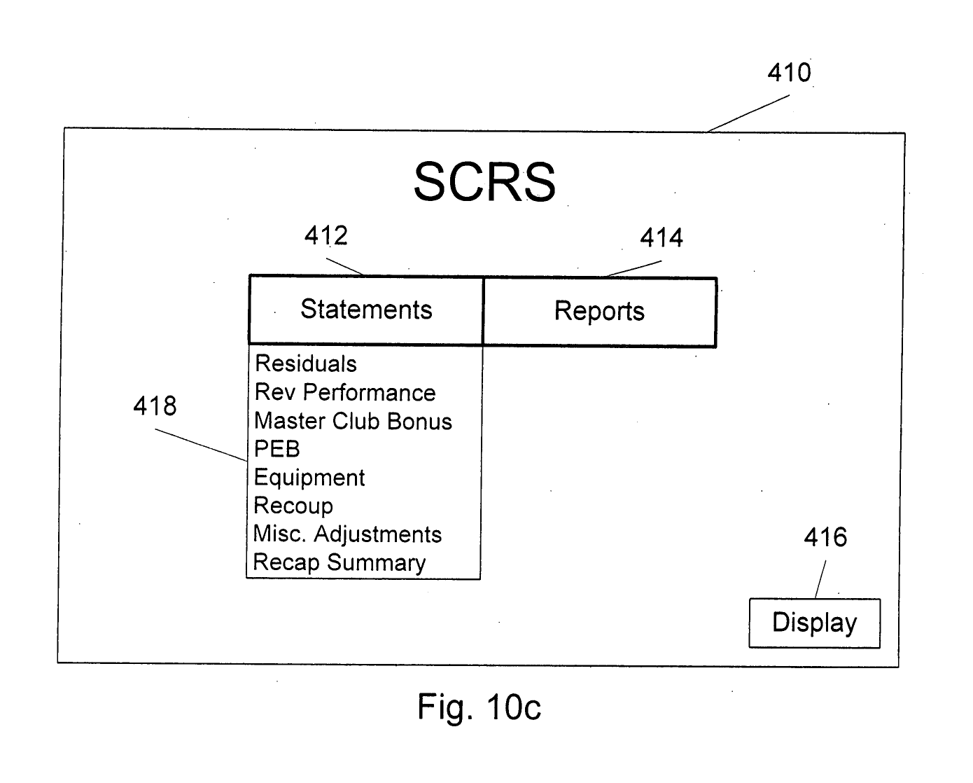

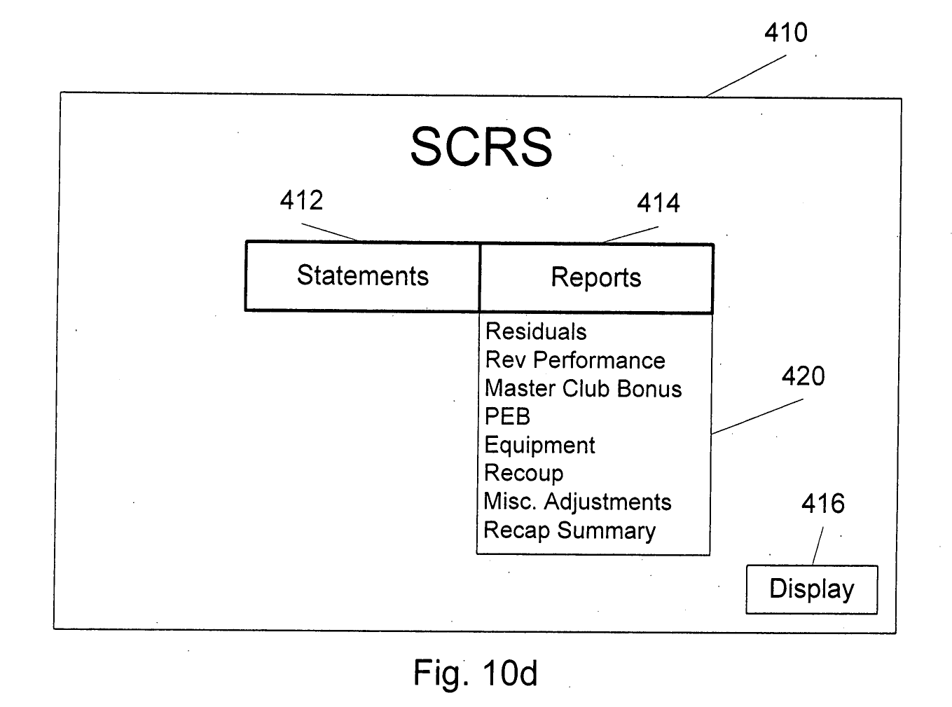

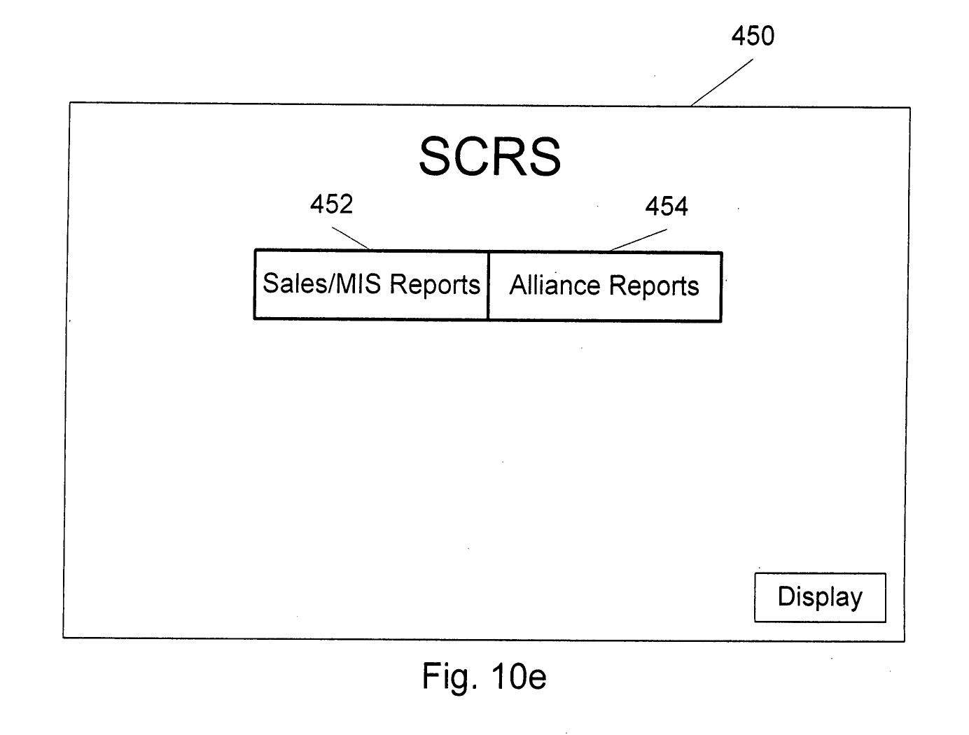

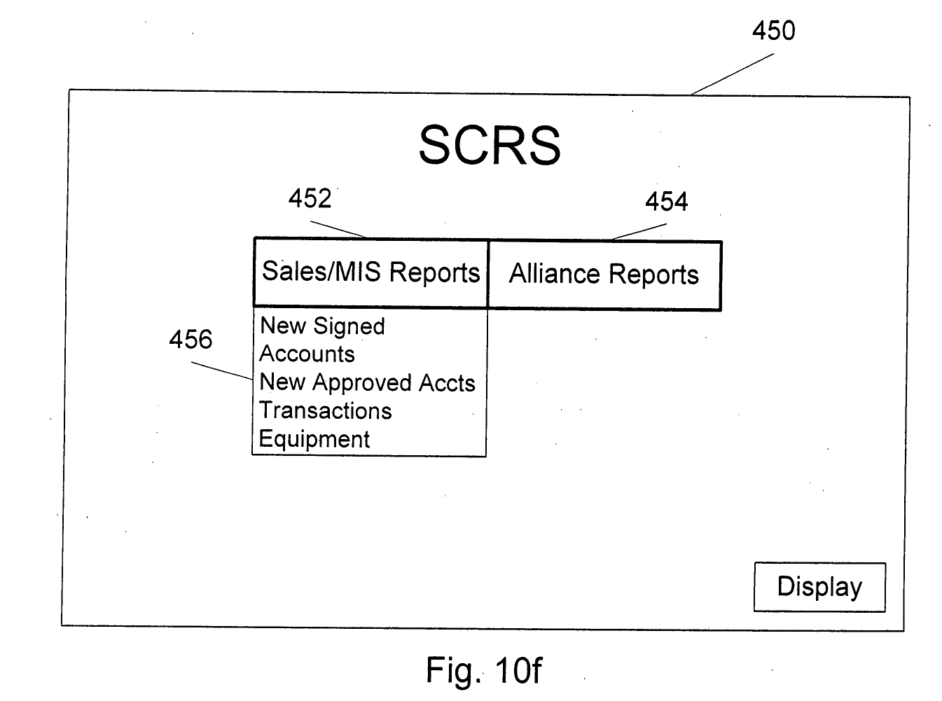

GUI templates may be stored in the Memory 144, for example. Examples of GUIs are discussed below with respect to FIGS. 10a-10f. The GUI may be modified, as necessary, by the Processor 142, for the particular user. For example, the options available on the GUI may vary based on the document types available to the particular user. Alternatively, the same GUI may be presented to each user, but selection of only certain options will cause retrieval of a corresponding document. The GUI may comprise options to select dropdown menus to display lists of categories of document types, for example. Document categories are discussed below.

Once a document type is selected, then additional options may be presented in another GUI, such as a date or time period for which a document is desired. After a selection is made, the selected document is retrieved and displayed. If the selected document has not been generated yet, it will be generated by the Report Generator 384, converted into a PDF document by the PDF Converter 386, and displayed, as discussed above. Alternatively, all available documents may be generated, converted into a PDF document, and stored prior to selection by a user. Selection by a user then causes retrieval of the stored PDF file. The displayed document may be saved by the user on the user's PC. The GUI may also present an option to convert the document into a spreadsheet, in which case the document is converted by the Spreadsheet Converter 388 and displayed, as is also discussed above. The displayed spreadsheet may also be saved on the user's PC.

As discussed above, in one example, three categories of document types may be accessed by authorized users of the System 100: 1) Statements, which may be accessed by sales reps; 2) Rep Reports, which may also be accessed by sales reps; and 3) Sales/MIS Reports, which may be accessed by managers, including Alliance managers. Data for Statement Reports and Rep Reports may be retrieved from the Commissions Database 240. Data for the Sales/MIS Reports may be retrieved from the Sales/MIS Database 360. Other or different reports may also be provided.

Statements relate to the calculation of commissions. The Statements may cover a current time period, such as one week or one month, for example. Multiple types of Statements may be provided. One or more Statements may be generated for each type of commissions component and adjustment, discussed above, as well as for the calculated earned commissions. For example, a Statement may be provided for the residuals, revenue performance, Masterclub Bonus, PEBS, and Equipment (sold, leased, installed) commissions components, and the recoup and miscellaneous adjustments, etc., which were discussed above, for a given time period. The underlying data contributing to the commissions calculation may also be provided in the report, itemized by merchant account, for example. Transaction dates may also be included. A Recap Summary Statement may also be provided to summarize the commissions earned in a prior month and year to date, for example. Underlying data may include sales and/or revenues, new accounts signed, equipment sold, etc.

Rep Reports are cumulative summaries of particular commissions components over a time period different than a corresponding Statement for the same component, such as daily, quarterly, yearly, and/or year to date, for example. Another Rep Report that may be provided is a Recap Summary Report, which provides a summary of the commissions received by the sales rep for a selected period, a year-to-date summary of the commissions earned for each commission component, and adjustments, for example.

Sales/MIS Reports provide summaries of activity of sales reps and managers below the manager requesting the report in the User Hierarchy Table of FIG. 7. For example, a territorial manager, such as the Territorial Manager 1, may request a Sales/MIS Report summarizing the activities of the sales reps reporting to that manager, in this case the Sales Rep 1 and Sales Rep 2. The report may include summary information for each sales rep and/or a total for all the sales reps. A district manager, such as the District Manager 2, may request a report providing a total of some or all of the activities of all the sales reps in that manager's district, in this case, Sales Rep 5, Sales Rep 6, Sales Rep 7, and Sales Rep 8. The district manager may also request a report providing a total of some or all of the activities of the sales reps for any or all of the territorial managers in the district, in this case Territorial Manager 3 and Territorial Manager 4. The same is true for regional and Alliance managers, who may obtain the same types of reports, in accordance with the User Hierarchy Table. The activities may include any or all of: signing of new accounts; approval of signed accounts; transactions conducted by active accounts; sales, lease, and installation of equipment; etc. The particular Sales/MIS Reports that are available may be determined by the System 100, the Alliance 17 and/or the manager. These are merely examples of types of Sales/MIS reports that may be provided. Other reports may be provided, as well, or instead of these examples.

FIG. 10a is an example of a Login screen 400 that may be presented by the System 100 for the input of login information. The Login screen 400 may be accessed by authorized users via a PC, such as PC1 through PCn, for example, by entering a web address. Fields 402, 404 are provided for input of a user ID and a password by a user interface device of a user's PC, such as PC1, respectively. The user interface device can be a keyboard (not shown), for example. After entry of the user ID and password, clicking on a Login button 406 causes processing that determines whether the password for that user is correct, in a manner known in the art. If the user ID and password match, further processing is performed to identify the information accessible by that user via one or more tables, for example, as discussed above.

If the user ID is that of a sales rep, a Sales Rep Reporting Screen 410 is displayed, as shown in FIG. 10b. The Sales Rep Reporting Screen 410 displays a Statements button 412, a Reports button 414, and a Display button 416. Placing the cursor of a user's interface device, such as a mouse, over the Statements button 502 causes display of a drop down menu 418 listing statements relevant to that sales rep, as shown in FIG. 10c. Separate Statements are available for each of the components and adjustments of the commissions calculation for that sales rep for a time period, such as one month, based on the compensation plan of the sales rep. Alternatively, a list of all types of statements available on the SCRS 100 may be displayed but only statements available to that sales rep may be opened. The available statement reports in this example are Residuals, Revenue Performance, Masterclub Bonus, PEBS, Equipment, Recoup, and Miscellaneous Adjustments.

Highlighting the particular report by clicking once on a report name, for example, and then clicking on the Display button 416 causes generation of a selected report. Alternatively, the GUI 410 may be arranged so that double clicking on a report name causes generation of a report. A Display button may not then be required.

Placing the cursor over the Reports button 414 causes display of the drop down menu 420 listing reports available to that sales rep, as shown in FIG. 10d. In the example of FIG. 10d, the available reports are the same as the available statements: Residuals, Revenue Performance, Master Club Bonus, PSB, Equipment, Recoup and Miscellaneous Adjustments. Recoup Summary is also available, in this example. If a Report may be prepared for multiple time periods, such as monthly, yearly, and/or year to date, a window may be displayed to present this option. A window may be presented to enter a time period, or a button or buttons may be presented to select a time period, for example.

In one example, after selection of a particular Statement or Report, an appropriate document is retrieved and displayed. If the document has not been generated yet, it may be generated after selection and then displayed.

If a supervisor or third party, such as an Alliance Manager, has logged in, a different window 450 is retrieved and provided to the user's PC1, as shown in FIG. 10e. The selection window 450 provides a Sales/MIS Reports button 452 and on Alliance Reports button 454 for selection. FIG. 10f shows a drop down menu 456 displayed upon placing a cursor over the Sales/MIS Reports button 452. The options include summary reports of New Signed Accounts, New Approved Accounts, Transactions, and Equipment, organized by sales rep and territory, for example. An Equipment Report summarizes equipment sold, such as terminals. Transactions is a summary of activity for all accounts. Other or different Reports may be provided, as well. Separate windows may be presented for supervisors and third parties.

The same report options may be provided if the user's cursor is placed over the Alliace Report button 454. The content of each report may be different, however. For example, the reports may include additional sales reps, and the report may not be organized by sales rep.

Necessary data for each statement or report is collected by the Reporting Manager 140, formatted, and converted into a PDF document or other document format for display on the user's PC and/or e-mail to the user's PC. The reports may be generated with a reporting tool, such as Crystal Reports 8.5, Developer Edition, available from Business Objects SA, San Jose, Calif., for example, as discussed above. ASP server side scripting and JAVA script client side scripting may also be used.

Some or all of the organized and summed data from the tables of FIG. 8 may be stored in the Sales/MIS Database 360 as needed for subsequent processing into reports for selective access by users by the Reporting Manager 140. For example, if a district manager is only to have access to summary information for certain territorial managers, then only summed data for the sales reps reporting to those territorial managers need be stored in the Sales/MIS Database 360, in association with that district manager. If the district manager is to have access to information related to each sales rep, then such data would also be stored in the Sales/MIS Database 360. If raw data is provided to the Sales/MIS Calculator 125 daily, for example, then updated, organized, and summed data may be transferred to the Sales/MIS Database 360 daily, as well. After a predetermined period of time, such as from 30 to 90 days, for example, old data may be transferred to the Sales/MIS History Database 362, where it may be stored for a longer period of time.

As mentioned above, after the document is formed, it may be e-mailed to a user via the E-mail Server 155 in FIG. 2. E-mail statements may be provided to sales reps to avoid the need and cost of mailing commissions statements. E-mail reports may also be provided to managers, to facilitate their receipt of Sales/MIS information. The document, prepared as described above, may be sent as an attachment in the e-mail, to users. Users may provide their e-mail address during a registration procedure. The e-mail address may be stored in a table in the Reporting Rules Database 390 of the Reporting Manager, for example.

Manager Collaborative Data Objects for Windows NT (“CDONTS”) or Message Application Program Interface (“MAPI”) may be used to e-mail the document. Visual Basic and ASP contain a reference to CDONTS, which provides various methods and properties that may be used to automate the e-mail process. The e-mails may be sent by Simple Mail Transfer Protocol (“SMTP”), for example. The SMTP is configured to communicate to the E-mail Server 155 to route the e-mails to the authorized users.

FIG. 10 is an example of a method 1000 of reporting commissions and Sales/MIS information in accordance with an embodiment of the invention. User login information is received, in Step 1010. The login information may be entered by a user on a PC and conveyed to the processor 142 of the Reporting Manager 140 via the network 160, such as the Internet, for example. The user is authenticated and available document types are identified for that user, in Step 1120, as described above with respect to the Authentication and Report Selection module 382. The available document types are provided to the user for display, in Step 1130, by the Reporting Manager 140 and the Web Server 150, for example. A selection is received from the user, in Step 1140, by the Reporting Manager 140, via the user's PC, the network 160, and the Web Server 150. If the document has been generated already, the selected document is retrieved, in Step 1150, and displayed in Step 1160. If the document has not already been generated, it is generated by the Report Generator 384 and the Converters 386 and/or 388, as described above, and then displayed.

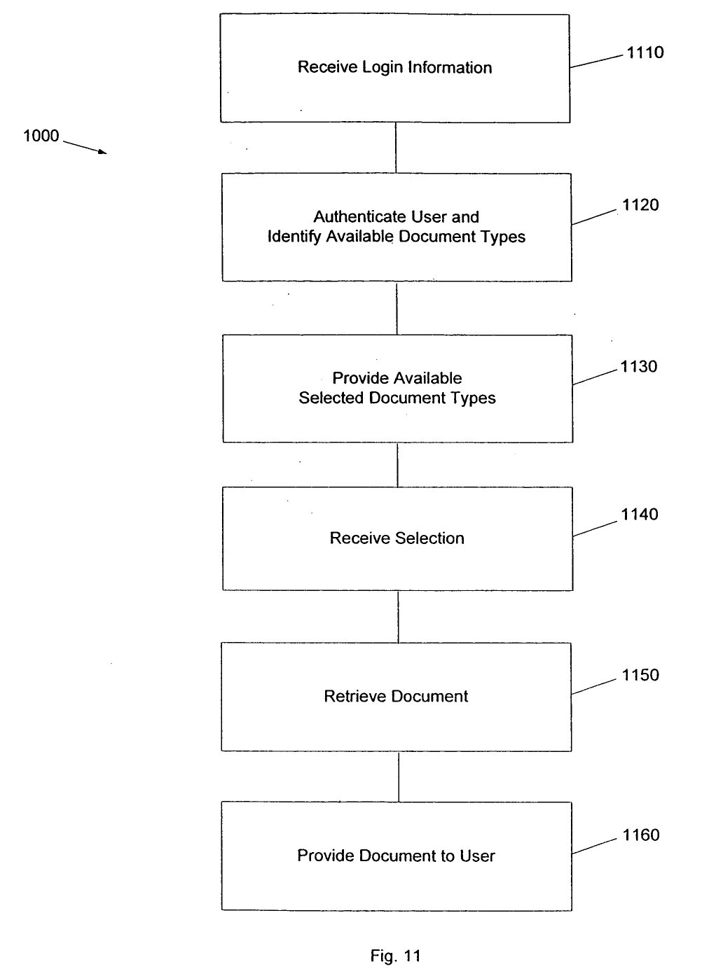

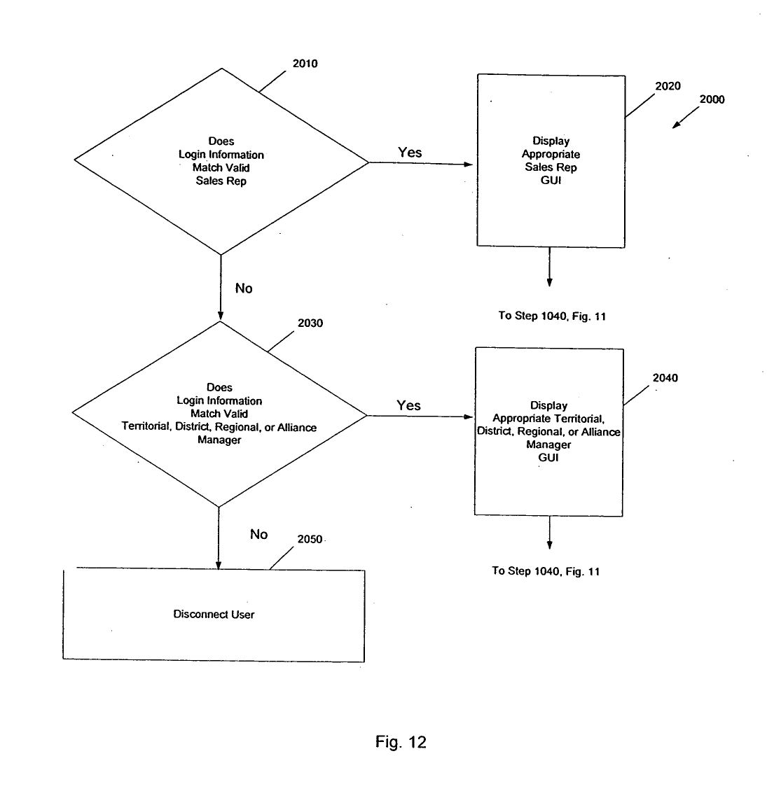

FIG. 12 is an example of a method 2000 for selecting and displaying an appropriate GUI including available document types and/or categories, corresponding to Steps 1020 and 1030 of FIG. 11. The selection is based on the login information. The proper login information for each type of user is stored in a separate table or tables. In Step 2010, it is determined whether the login information matches the identification of a valid sales rep. This may be done by comparing the login information to entries in a table correlating login information with valid sales reps. If there is a match, a sales rep selection page is displayed, in Step 2020. The sales rep selection page (GIL) may be retrieved from memory 144 of the Reporting Manager 140, for example, and conveyed to a user's display device via the Internet, for example.

If there is not a match in Step 2010, then it is determined whether the login information matches that of a valid territorial, district, regional, or Alliance manager, in Step 2030. This may be done by comparing the login information to entries in one or more tables correlating login information with valid managers. If there is a match, then an appropriate GUI for that manager, including the available document types, is displayed, in Step 2040. The GUI may be retrieved from memory 144, for example, and conveyed to the user's display device via the Internet or other such network, for example. If there is no match in Step 2030, then the user is disconnected, in Step 2050. If there is a match, after display of the appropriate selection page in Steps 2040, the method 1000 returns to FIG. 11, Step 1040, to receive a selection through the displayed GUI. It is noted that the method of FIG. 12 is merely an example and the tables may be accessed in any order.

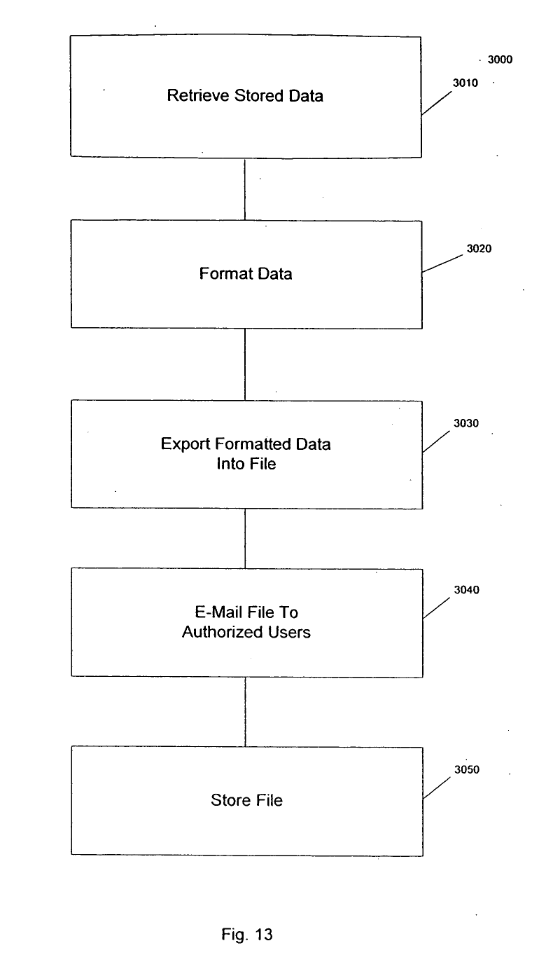

FIG. 13 is an example of a method 3000 for generating documents for e-mailing to users. In this example, documents are generated automatically and periodically. Stored data is retrieved, in Step 3010. If the data is Sales/MIS data, it may be retrieved daily, for example. If the data is commissions data, it may be retrieved monthly, for example. The particular document or documents to be e-mailed are predetermined by the system, the Alliance, and/or the managers, based on the user, and the appropriate data is retrieved for that document by the Report Generator 384, for example. The data is formatted, in Step 3020. The formatted data is exported into a file, in Step 3030. In this example, the file may be a PDF or spreadsheet file. The user may have the option to select the file type, or the System 100 may determine the file type. The file is then e-mailed to authorized users, in Step 3040. The generated documents may be stored by the System 100, in Step 3050, for later retrieval after a request by a user, as well. The documents may be stored in the memory 144 of the Reporting Manager 140, for example.

Other Systems may use some or all of this type of information and other information, dependent upon the environment the system is used in (type of business, for example) and the particular details of the commission payment plans being implemented. The same or different documents may be generated. While the System 100 has been described above in the context of the credit and debit card industry, such a system may be used in any industry where commissions are paid. In addition, while described above with respect to a system hiring sales reps to represent Alliances, the methods and systems described herein are applicable to systems hiring sales reps to represent any third party or to represent the system itself. The system and third parties may be involved in card processing, other financial transactions, or the sale of any types of products and services, whether financial or not.

The embodiments above are examples of implementation of the invention. Modifications may be made without going beyond the spirit and scope of the invention, which is defined by the claims, below.

We claim:

1. A method of generating commissions documents, comprising:
calculating commissions earned by a party based, at least in part, on stored data related to the party;
generating at least one file comprising at least one of the calculated commissions and the stored data; and
converting the at least one file into at least one read-only file.

2. The method of claim 1, further comprising:
selectively providing access to the at least one read-only file via a network.

3. The method of claim 1, further comprising:
receiving login information from a user; and
selectively providing access to the at least one read-only file based, at least in part, on the login information.

4. The method of claim 3, wherein the user is a sales representative and the party and the user are the same, the method comprising:
providing access to at least one read-only file to the sales representative.

5. The method of claim 3, wherein the user is a supervisor of at least one party and the at least one read-only file comprises stored data related to activities of the at least one party, the method comprising:
providing the supervisor access to the read-only file.

6. The method of claim 3, wherein the user is a supervisor of at least one supervisor of at least one party and the at least one read-only file comprises stored data related to activities of the at least one party, the method comprising:
providing the supervisor access to the read-only file.

7. The method of claim 4, wherein the user is a third party, at least one sales representative represents the third party, and the read-only file comprises data related to the activities of the at least one sales representative representing the third party, the method comprising:
providing the third party access to the at least one read-only.

8. The method of claim 4, comprising:
generating the at least one file based, at least in part, on a position of the user in a hierarchy table defining relationships between users.

9. The method of claim 8, comprising:
loading the stored data into respective tables based, at least in part, on the hierarchy table; and
retrieving the information from the respective tables to generate the at least one file.

10. The method of claim 1, further comprising:
sending the read-only file to the user by e-mail.

11. The method of claim 1, comprising:
calculating the commissions for a party based, at least in part on the stored data and stored business rules.

12. The method of claim 13, wherein the business rules are stored in tables.

13. The method of claim 1, comprising:
selectively displaying selection links to information available to the user based, at least in part, on the login information.

14. The method of claim 1, wherein the read-only file is a PDF file or a read-only HTML file.

15. The method of claim 1, further comprising:
receiving login information from a user; and
generating the at least one file based, at least in part, on the login information.

16. A method of generating financial documents, comprising:
collecting data related to activities of a plurality of sales representatives;
loading the collected data into respective tables based, at least in part, on a hierarchy table defining the relationships between the sales representatives and supervisors of the sales representatives; and
generating at least one file based, at least in part, on data in at least one respective table.

17. The method of claim 16, comprising:
loading the data for sales representatives supervised by a first respective supervisor into a first respective table.

18. The method of claim 17, comprising:
loading the data for sales representatives supervised by first respective supervisors supervised by a second respective supervisor, into a second respective table.

19. The method of claim 17, further comprising:
loading the data for sales representatives representing a respective third party into a third respective table.

20. The method of claim 16, wherein the activities relate to transactions concerning products or services.

21. The method of claim 20, wherein the products or services are a third party's products or services.

22. The method of claim 20, further comprising:
loading data related to respective sales representatives into respective tables; and
generating a file comprising calculated commissions for each respective sales representative.

23. The method of claim 16, further comprising:
receiving login information from a user; and
selectively providing access to a respective file based, at least in part, on the login information.

24. The method of claim 23, further comprising:
converting the file into a read-only file; and
providing access to the read-only file.

25. The method of claim 23, wherein the user is a sales representative, the method comprising:
providing the sales representative access to the at least one file related to the sales representative.

26. The method of claim 23, wherein the user is a supervisor of sales representatives, the method comprising:
providing access to the at least one file related to the sales representatives supervised by the user.

27. The method of claim 23, wherein the user is a supervisor of supervisors of sales representatives, the method comprising:
providing access to the at least one file related to the sales representatives supervised by the supervisors.

28. The method of claim 23, wherein the user is a third party, the method comprising:
providing access to the at least one file related to the sales representatives representing the third party.

29. The method of claim 23, comprising:
selectively displaying selection links to information based, at least in part, on the login information, to the user.

30. The method of claim 16, further comprising:
e-mailing the at least one file to an authorized user.

31. A method of generating financial documents, comprising:
collecting data related to activities of a first plurality of parties;
loading the collected data into respective tables based, at least in part, on a hierarchy table defining the relationships between the first plurality of parties and a second plurality of parties; and
generating at least one file comprising data in at least one respective table.

32. The method of claim 31, wherein the second plurality of parties comprises supervisors of the first plurality of parties.

33. The method of claim 31, wherein the second plurality of parties comprises third parties represented by respective ones of the first plurality of parties.

34. A method of generating commissions statements, comprising:
calculating commissions for a party based, at least in part, on stored data;
generating at least one file comprising the calculated commissions and data related to the calculated commissions; and
e-mailing the at least one file to the party.

35. The method of claim 25, further comprising:
converting the file into a read-only file prior to e-mailing; and
e-mailing the read-only file to the party.

36. The method of claim 26, further comprising:
storing the file; and
selectively providing access to the file to a user based, at least in part, on login information provided by the user.

37. A system to generate commissions statements, the system comprising:
memory; and
a processor configured to:
collect data related to activities of a plurality of sales representatives;
load the collected data into respective tables in the memory based, at least in part, on a hierarchy table defining the relationships between the sales representatives and supervisors of the sales representatives; and
generate at least one file based, at least in part, on data in at least one respective table.

38. The system of claim 37, wherein the processor is configured to:
load the data for sales representatives supervised by a first respective supervisor into a first respective table.

39. The system of claim 38, wherein the processor is configured to:
load the data for sales representatives supervised by first respective supervisors supervised by a second respective supervisor, into a second respective table.

40. The system of claim 39, wherein the processor is configured to:
load the data for sales representatives representing a respective third party into a third respective table.

41. The system of claim 37, wherein the processor is configured to:
load data related to respective sales representatives into respective tables; and
generate a file comprising calculated commissions for each respective sales representative.

42. The system of claim 37, wherein the processor is configured to:
selectively provide access to a respective file based, at least in part, on login information provided by a user.

43. The system of claim 42, wherein the processor is configured to:
convert the file into a read-only file; and
provide access to the read-only file.

44. The system of claim 42, wherein the processor is configured to:
selectively display selection links to information based, at least in part, on the login information, to the user.

45. The system of claim 37, wherein the processor is configured to:
e-mail the at least one file to a authorized user.

46. A system for generating commissions statements, the system comprising:
memory;
a processor configured to:
calculate commissions for a party based, at least in part, on stored data;
generate at least one file comprising the calculated commissions and data related to the calculated commissions;
store the at least one file in the memory; and
e-mail the at least one file to the party.

47. The method of claim 46, wherein the processor is further configured to:
selectively provide access to the file to a user based, at least in part, on login information provided by the user.
